(19) United States
(12) Patent Application Publication
(10) Pub. No.: US 2010/0011640 A1
(43) Pub. Date: Jan. 21, 2010

(54) NON-INTERACTIVE ADVERTISING SYSTEM AND METHOD FOR USE WITH GOLF CARTS

(76) Inventor: Donald C. Holm, Salt Lake City, UT (US)

Correspondence Address: KIRTON AND MCCONKIE, 60 EAST SOUTH TEMPLE,, SUITE 1800, SALT LAKE CITY, UT, 84111, US

(21) Appl. No.: 12/173,269

(22) Filed: Jul. 15, 2008

(51) Int. Cl. G09F 21/04; G09F 7/18

(52) U.S. Cl. 40/592

(57) ABSTRACT

A non-interactive advertising display is provided for use by golfers in their golf carts, which supplies useful advertising information to the cart occupant(s). In some cases, the display holds print advertisements protected under a clear removable film. Furthermore, the system is free from being unduly obtrusive in comparison to some interactive advertising methods due to its static, printed delivery—which can be free from animation, video or sound—and its unique placement, mounting under the front of the roof of the cart as opposed to the roof mounting poles. The advertising display can be used to attach to many commonly occurring golf cart roof shapes. This is due to a universal design and removable mounting brackets. Furthermore, the non-interactive advertising display can be maintained without the use of tools. Because the display can be manufactured in a way that purposefully matches cart roof colors this further minimizes the display's obtrusiveness.

### BACKGROUND OF THE INVENTION

1. Field of the Invention

The present invention relates to methods and apparatus for providing a non-interactive advertising system, particularly for golf cart application, designed to increase revenues for golf courses and also to supply useful and interesting information to golfers, in a manner which is maximally effective and minimally intrusive.

2. Background and Related Art

Advertisers are constantly looking for new and more effective, cost-efficient methods of introducing their products and services to customers likely to utilize and appreciate them. The golfer demographic is the most widely sought after consumer by advertisers, because of its affluence, yet the only traditional way of reaching this demographic has been through traditional advertising. This advertising has limited reach, and it does not capture the golfer at the golf course.

Non-interactive Golf cart advertising may virtually be non-existent at present. Occasionally, advertising can be found on the back of scorecards and as a component of some Global Positioning System (GPS) systems currently available in the market, for golf course use. Advertising is limited, because it is often up to the individual golf courses equipped with such systems to sell and install the advertising. The average cost of such GPS systems can be $200,000 or more per golf course. For this reason, market penetration is currently estimated to be less than about 2% of U.S. golf courses. By implementing a non-interactive, printed advertising display, a higher penetration is much more attainable.

The under-side of the most common golf cart roofs can differ greatly, making a universally designed advertising display difficult to mount to the roof underside and costly to produce for golf courses at large. The approach of competing advertising displays might be to mount a display to the poles that connect the cart roof to the golf cart. This may result in a less expensive ad display to produce; however, it is believed that this alternate method increases the obtrusiveness of the advertising displays. The proposed advertising display herein is designed to solve this problem by its unique overall design, which can be easily configured for mounting on the underside of ubiquitous roof designs similar to those of EZ GO, YAMAHA, CLUBCAR, and other golf cart roofs.

Golf courses need an advertising display requiring minimal effort to change the printed advertisements. Other applications could require tools such as screwdrivers or small wrenches, whereas in this embodiment advertisements can be printed on heavy paper stock (or another suitable medium) and the advertisements may slide into the ad display without the need for tools. In some cases, the described ad display utilizes a protective clear covering, which slides into the ad display without the need for tools. This clear covering acts to protect the printed non-interactive advertisements.

### SUMMARY OF THE INVENTION

The present invention satisfies the above described objectives, by providing a highly effective advertising system for use by golfers in their golf carts. The advertising system can supply useful product or service information to the golfer without the need for frequent manual maintenance by the golf course. Furthermore, the inventive system also accomplishes this without being unduly obtrusive. A unique and advantageous method of doing business, also comprising a part of the present invention, can benefit golf courses by permitting them to obtain additional revenues from the advertisements.

More particularly, in one aspect of the invention there is a mounting bracket, which is removable, and attaches to the back of the overall ad display unit frame. When removed, it allows for attachment to cart roofs, which comprise a built-in angle to the roof design, such as golf cart roofs in the style of EZ GO brand roofs. Because of this unique configuration, the advertising display can accomplish a truly universal application with this style of roof as well as roofs which are more flat such as the style of YAMAHA, CLUBCAR, or other more ubiquitous roof styles.

The advertising display is mounted to position the face of the advertisements towards one or more occupants of the golf cart. Indeed, in some cases, the advertising display is mounted at a preferable angle of approximately 45 degrees past perpendicular in the line of sight of occupants to the golf cart

In still another aspect of the present invention, there is provided a series of undercuts, which are small grooves which the advertisements and clear protective cover may slide securely into without the use of tools. In some cases, the undercuts run the length of the horizontal top and bottom edges of the display as well as the left and right vertical sides.

While the apparatus, methods, and processes of the present invention have proven to be particularly useful in the area of advertising to golfers in golf carts, those skilled in the art can appreciate that the apparatus, methods, and processes can be used in a variety of different applications and in a variety of different areas including for advertising to any suitable occupant of a golf cart or similar vehicle in which the advertising display may be implemented.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 is a side view of a representative embodiment of a golf cart roof, which does not require removable mounting brackets.

FIG. 2 is a side view of a representative embodiment of a golf cart roof that does not require mounting brackets, wherein a representative embodiment of an advertising display is attached to the roof without using the removable mounting brackets.

FIG. 3 is a left side view of a representative embodiment of a traditional golf cart roof, with a horizontal mounting surface requiring the removable mounting brackets of the advertising display.

FIG. 4 is a side view of a representative embodiment of a traditional style golf cart roof and a representative embodiment of the mounted advertising display implementing removable mounting brackets.

FIG. 5 is a perspective view of a representative embodiment of the advertising display holder with sample advertisements.

FIG. 6 shows a first representative embodiment of a method for inserting advertising, with the advertisements and clear plastic cover being inserted by bending them convexly and tucking them under a top and/or a bottom undercut of the ad display.

FIG. 7 shows a second representative method for inserting advertising insertion, with the advertisements and clear plastic cover being inserted by bending them convexly and sliding them into a narrow opening on the side of a representative embodiment of the advertising display.

FIG. 8 shows a third representative method for inserting advertising insertion, with the advertisements and clear plastic cover being inserted by folding open a hinged cover which, when closed holds the ads securely in place in accordance with the principles of the present invention.

FIG. 9 shows a fourth representative method for inserting advertising insertion, with the advertisements and clear plastic cover being inserted by taking off a removable cover which, when snapped or screwed to the front of the display, holds the ads in place in accordance with the principles of the present invention.

FIG. 10 shows a representative embodiment of the advertising display holder for use with a golf cart roof with a built in angled mounting surface.

FIG. 11 shows a cutaway view of representative view of display holder and removable bracket.

### DETAILED DESCRIPTION OF THE INVENTION

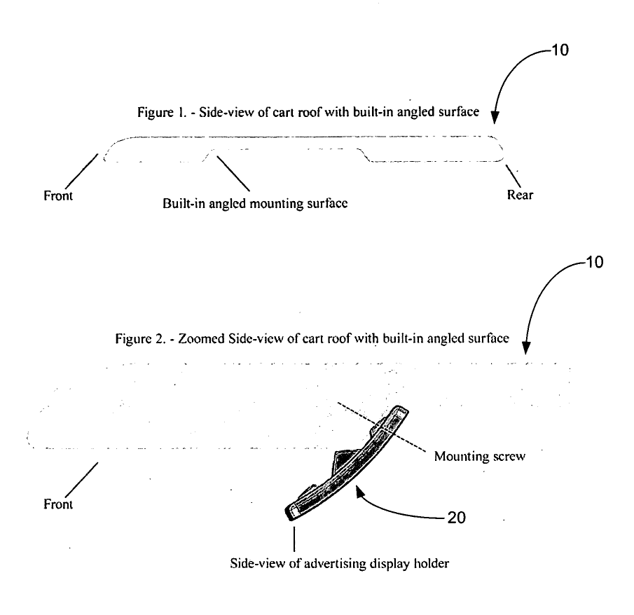

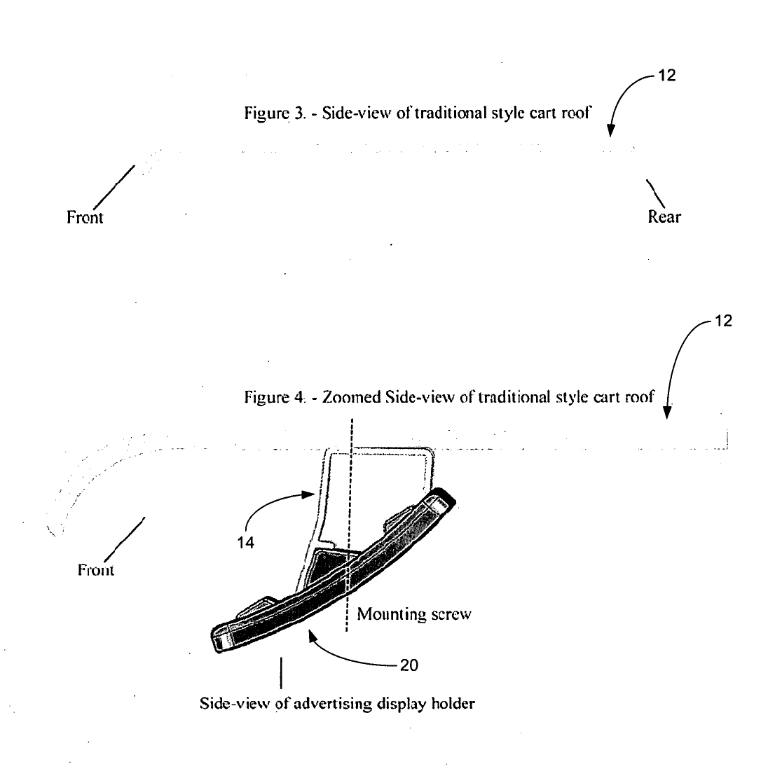

Referring now to FIGS. 1-11, there is shown representative embodiments of two main types of golf cart roofs 10 and 12 (FIGS. 1, 3) which demonstrate the range of mounting surfaces for which the described universal advertising display 20 (FIGS. 2 and 4) may accommodate. The advertising display system is designed to be utilized in combination with known golf carts, including, for example, those manufactured by EZ GO, YAMAHA, and CLUBCAR. Some carts, such as the EZ GO style cart, may comprise a roof that is unique in that it has an angled surface to the roof in the area where mounting of said non-interactive advertising display would mount. More ubiquitous roof styles in the manner of YAMAHA and CLUBCAR may not have this built-in angled surface and are more of a flat surface. By way of removable mounting brackets in some embodiments 14 (FIGS. 2, 4, and 11) the advertising display 20 can account for this range of mounting surfaces for a universal application. In some embodiments the bracket 14 can be attached to the frame 21 using a ball and socket (FIG. 11). In other embodiments the bracket can be secured with screws, snaps or other mechanisms.

Typically, the advertising display is mounted 20 (FIGS. 2, 4) under the front of the roof of the golf cart roof, facing 1 or more occupants of the cart who are sitting in a forward-facing position. The angle at which the advertisements are displayed can be any suitable angle that allows occupants to view the advertisements. In some cases, the display is angled from between about 30 to about 60 degrees past vertical. In other cases, however, the display is angled so that advertisements are displayed at about 40 to about 50 degrees (e.g., about 45 degrees) past vertical. In such instances, the advertising display can be unobtrusive while providing line-of-sight visibility.

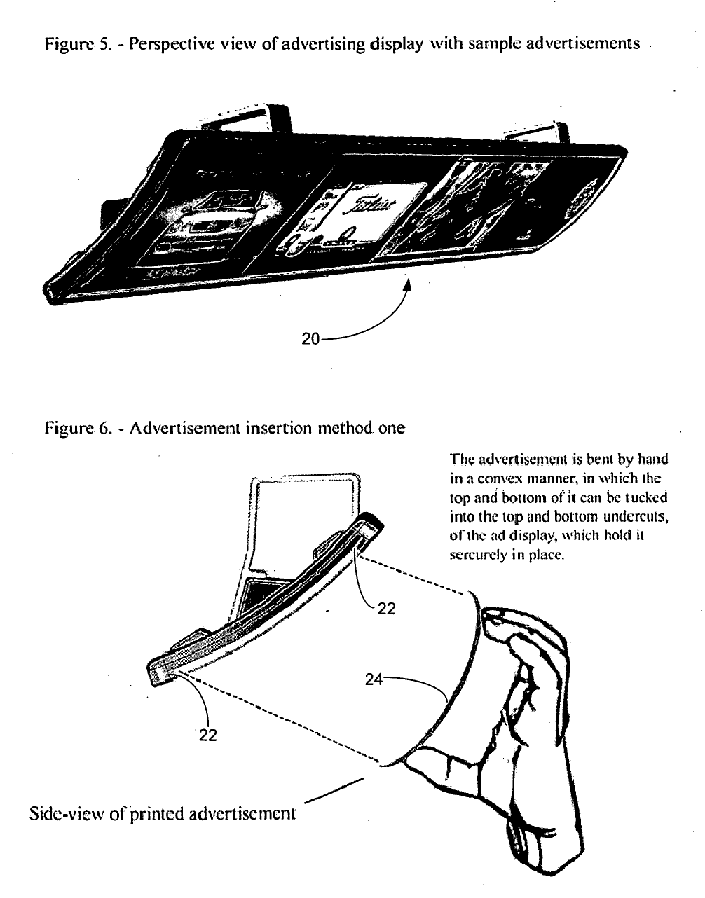

Now with particular reference to FIG. 5, there is shown a schematic representation of some embodiments of the advertising display whose width is close to that of a golf cart roof's horizontal width (not shown), accommodating one or more advertisements of varying widths.

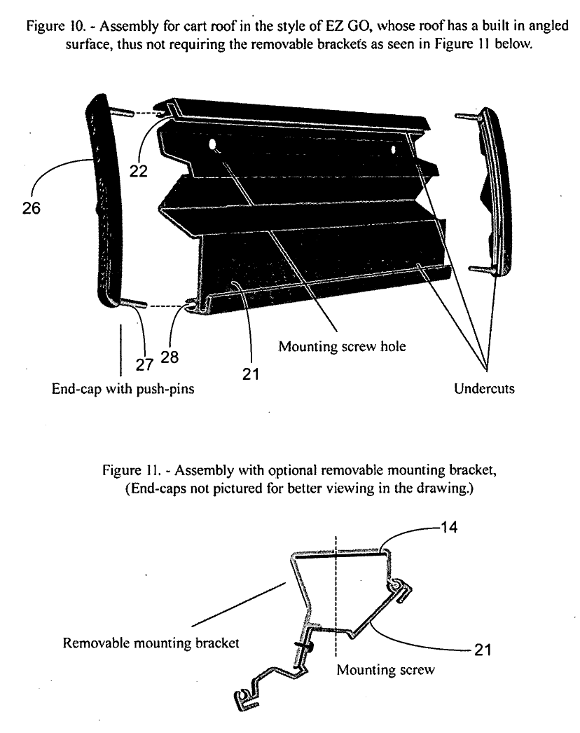

In FIG. 6, the use of some embodiments of undercuts 22 is illustrated, thus resulting in the absence of need for specific tools to insert, secure, or remove the advertisements and their clear protective cover 24, by way of bending them to be securely tucked into the advertising display. Similarly, FIG. 10 shows some embodiments in which end-caps 26 attach to the side of the frame so as to retain the cover and advertisements (not shown) within the undercuts 22 of the display 20. In such embodiments the end-caps can be attached to the display in any suitable manner. In one example, the end-caps are attached with screws, bolts, or the like. In another example, however, the end-caps are attached in a manner that does not require one or more tools to attach or detach the end caps from the frame. For instance FIG. 10 shows some embodiments where the end caps 26 are attached to the frame 21 with push pins 27 that mate with corresponding grooves 28 in the frame 21.

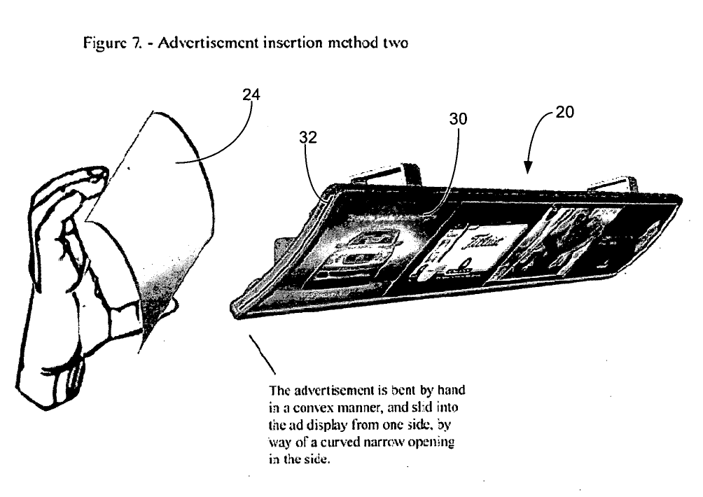

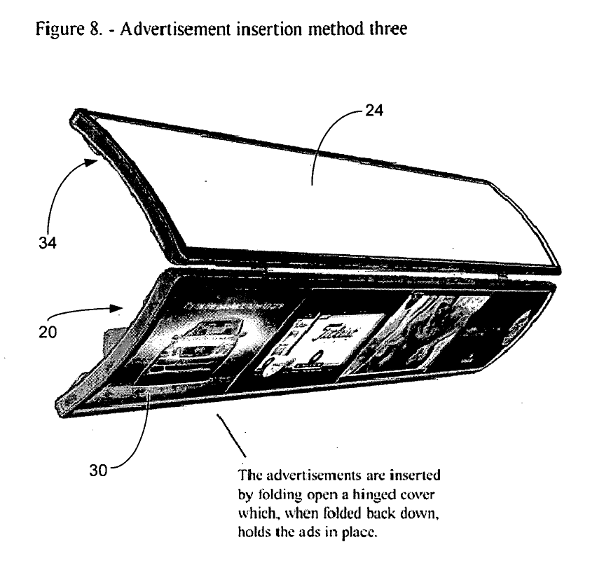

Optional insertion method number two (FIG. 7) demonstrates how advertisements 30 and the clear protective cover 24 can be slid into a narrow opening 32 on the side of the advertising display 20.

Optional insertion method number three (FIG. 8) demonstrates how advertisements 30 and the clear protective cover 24 can be placed into the advertising display 20 by way of a hinged cover 34, which folds open and again folds to a closed position to hold them securely in place.

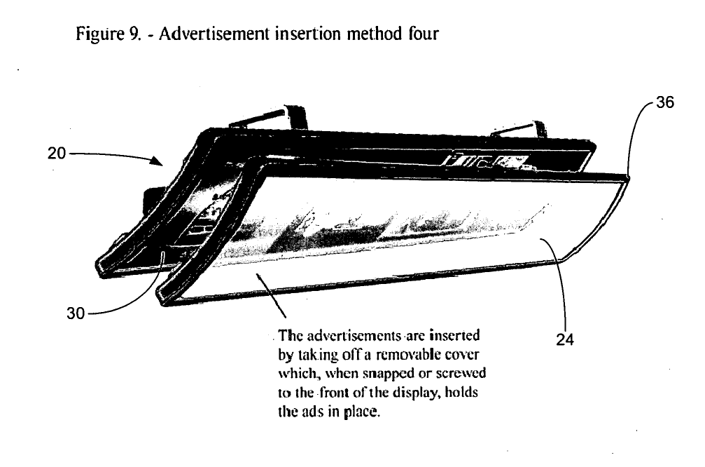

Optional insertion method number four (FIG. 9) demonstrates how advertisements 30 and the clear protective cover 24 can be placed into the advertising display 20 by way of a removable frame-like cover 36, which snaps, slides, screws or otherwise is securely connectable to the advertising display 20. In one embodiment, the clear protective cover is attached to the advertising display using plastic tabs molded into the frame so as to snap into grooves. In other embodiments, the cover can be attached with screws, snaps, or other applicable mechanisms.

The actual advertising content is designed by each client. A preferred business method is to charge each client a fixed price per quarter, per advertising spot, based on the number of participating golf courses and the number of golfers who will see the advertisements. Included in this price might be the cost of printing the advertisements.

The materials used to manufacture the display can be chosen to match the color of the roofs for which they will be installed, to maximize the unobtrusiveness of the advertising, minimize the occurrence of complaints from cart occupants and have a better appearance than is possible by some other means.

The absence of video, sound or animation also minimizes this intrusiveness, which should further reduce the potential of complaints from cart occupants (e.g., golfers), and thus draw interest from courses which might have this concern.

The advertisements themselves can be printed on any suitable medium, including a heavy card stock at magazine quality. This quality of advertisements may increase the appeal and photographic quality of the advertisements, thus further reducing the risk of complaints from golfers.

As mentioned, in some embodiments, the advertisements are protected by a clear cover. Such a cover may comprise any suitable material, including a polycarbonate, an acrylic, a polymer, or another similar material which can deter vandalism and protect the advertisements from weather.

The apparatus and method of the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A golf cart advertising display, comprising:
an advertising display holder configured to hold one or more printed advertisements; and
means for connecting the holder to a front underside surface of a golf cart roof so that the advertisements are displayed at an angle that is from about 30 to about 60 degrees past vertical.

2. The display of claim 1, wherein the connecting means is configured to display the advertisements at an angle that is from about 40 to about 50 degrees past vertical.

3. The display of claim 1, wherein the connecting means comprises at least one removable bracket.

4. The display of claim 1, further comprising a clear protective cover that attaches to a front side of the holder so as to cover the advertisements.

5. The display of claim 4, wherein the cover attaches to the holder through the use of undercuts.

6. The display of claim 4, wherein the cover attaches to the holder with at least one hinge.

7. The display of claim 4, wherein the cover snaps or screws to the holder.

8. The display of claim 4, wherein the cover slides into a narrow opening disposed on a side of the holder so as to cover the advertisements.

9. A method of providing a non-interactive media system for use in golf carts, comprising:
an advertising display holder configured to hold one or more printed advertisements; and
means for connecting the holder to a front underside surface of a golf cart roof so that the advertisements are displayed at an angle that is from about 30 to about 60 degrees past vertical.

10. The method of claim 9, wherein the connecting means is configured to display the advertisements at an angle that is from about 40 to about 50 degrees past vertical.

11. The method of claim 9, wherein the connecting means comprises at least one removable bracket.

12. The method of claim 9, further comprising a clear protective cover that attaches to a front side of the holder so as to cover the advertisements.

13. The method of claim 12, wherein the cover attaches to the holder through the use of undercuts.

14. The method of claim 12, wherein the cover attaches to the holder with at least one hinge.

15. The method of claim 12, wherein the cover snaps or screws to the holder.

16. The method of claim 12, wherein the cover is slid into a narrow opening disposed on a side of the holder so as to cover the advertisements.
